(19) United States
(12) Patent Application Publication
(10) Pub. No.: US 2022/0176215 A1
(43) Pub. Date: Jun. 9, 2022

(54) GOLF CLUB SHAFT AND METHOD OF MAKING THE SHAFT

(71) Applicant: Robin D. Arthur, San Diego, CA (US)

(72) Inventor: Robin D. Arthur, San Diego, CA (US)

(21) Appl. No.: 17/117,044

(22) Filed: Dec. 9, 2020

(51) Int. Cl. A63B 53/10; A63B 53/02; B29D 99/00

(52) U.S. Cl. CPC A63B 53/10; A63B 2209/023; B29D 99/00; A63B 53/02

(57) ABSTRACT

A method of making a golf shaft, and a shaft made thereby, for connection to a golf club head including a first upper section having a first diameter and an upper butt end; a second lower section having a second lesser diameter than said first diameter and a having a lower tip end for connection to the golf club head; and, a gradually tapering intermediate section connected between the first upper section and the second section that reduces the outside diameter of the shaft from the diameter at the upper section to the diameter of the lower section. The location of the intermediate section relative to the upper butt end of the shaft is determined by a weight value of the shaft such that as the weight of the shaft becomes lighter, the tapered intermediate section is located closer to the upper butt end of the shaft and the tapered intermediate section is located further from the upper butt end of the shaft as the shaft becomes heavier.

### BACKGROUND OF THE INVENTION

The present invention relates to golf shafts and in particular using a unique, distinct, and localized tapered section along the length of golf shafts to increase clubhead speed of a golf club without a change in the golfer's particular swing profile.

A typical golf shaft is comprised of three sections: an upper, mostly parallel (butt) section of varying lengths to accommodate the grip which fits into a golfer's hands; a gradually tapering middle section that runs from the upper section to a lower (tip) section; and, a lower tip section that can be of a specific parallel length. An exception to this parallel tip section is that some iron golf club heads are designed with a “hosel” section that has been bored out to accept a shaft with an approximate 1.5″ taper section at the tip end of the shaft. For the purpose of this invention, it is irrelevant if the golf club head accepts either a golf shaft with either a parallel or tapered shaft as either can be accommodated with this shaft invention.

There have been attempts in the past to incorporate different geometries promising increases in distance and enhanced control and consistency in golf shots. Most notably was the Taylor Made “Bubble” golf club program which used golf shafts having an upper bulbous section immediately below the grip which provided a concentration of weight which increased the entire club's Moment of Inertia thereby increasing club head speed. In actuality, that unique geometry fell short of its promise of having a concentration of weight as marketed that contributed to a higher Moment of Inertia nor did it result in any increase in club head speed.

Applicant has been marketing shafts with a rapid taper section and reference is made to applicant's own U.S. Pat. No. 1,061,596 titled Method of Filament Winding a Variable Diameter Golf Shaft describing a method of making a golf shaft of the type relating to the present invention. However, these shafts do not have the features of the present invention relating to shaft weight and the corresponding position of an intermediate, rapidly tapering section.

### SUMMARY OF THE INVENTION

The present invention relates to the design of a golf shaft having very distinct sections whose specific locations have proved to result in 2-6 miles per hour increase in club head speed for wood, fairway wood, hybrid and iron golf clubs.

Based on the laws of physics, any structure that has a force or energy applied to a mass, that energy remains constant until the mass structure is acted upon. It follows energy applied to a golf shaft is created when the shaft is swung by a golfer and that energy is transferred to the golf ball. When a conventional golf shaft with gradual taper is swung, the energy is gradually released from the upper butt end of the shaft to the tip section prior to impact with a golf ball. When a shaft incorporates a rapid taper section below the grip, the mass of the shaft is decreased dramatically due to a smaller diameter of the lower section of the shaft. This reduction in mass is offset by an increase in acceleration for any given force applied by the golfer swinging a golf club. It follows the increase in acceleration of the club results in a measurable increase in the distance the ball flies for a given golf swing.

The shaft of the present invention is formed of an upper top or butt section having a first diameter, a lower section having a second lesser diameter than the upper section diameter and further includes a tip that is connected to a golf club head and an intermediate tapering section that transitions from a maximum diameter at the junction of the upper butt section to a minimum diameter at the junction corresponding to the diameter of the lower section thus reducing the outside diameter of the upper section to that of the lower section.

It has been found that the overall weight of the shaft, that is the mass, increases, the rapid taper section is located further from the upper end of the shaft thus reducing the overall length of the smaller diameter lower section of the shaft. As the length of the upper section increases, more of the total mass of the shaft is located at the upper, larger diameter end. The location of the rapid taper section further from the upper end of the shaft compensates for the increased weight at the upper end in order to maintain the acceleration parameters of the shaft to insure maximum performance.

Therefore in keeping with the improved features of the shaft of the present invention, a distinct rapid taper section of a shaft is located within a range of very specific areas along the length of the golf shaft, the exact location being determined by the total weight of the shaft and stiffness distribution to maximize the increase in club head speed and provide a higher degree of control/consistency. More specifically, the location of the rapid taper is determined by the overall weight of the shaft such that a heavier shaft has the beginning of the rapid taper farther away from the upper butt end of the shaft and the lightest weight shaft has the beginning of the rapid taper closest to the upper butt end of the shaft.

In precisely locating the taper section as it relates to weight and stiffness distribution the specific the Laws of Physics mentioned are utilized and explain why there is an increase in clubhead speed. Even though the upper section with a larger outside diameter is gradually becoming longer with an increase in mass, the percentage of the smaller section after the rapid taper retains a much larger percentage of the overall mass of the golf shaft. The Law of Kinetic Energy therefore dictates in order to maintain the principles of the Law of Conservation of Energy the lower section must increase in acceleration, in this case evidenced by an increase in clubhead speed.

Among the objects of the present invention is the provision of a golf shaft having maximum performance characteristics by locating a rapid taper section between upper and lower sections of the shaft relative to the weight of the shaft.

Other objects are apparent with reference to the following detailed description and accompanying drawing.

### DESCRIPTION OF THE DRAWINGS

FIG. 1 illustrates a golf club shaft in accordance with the present invention.

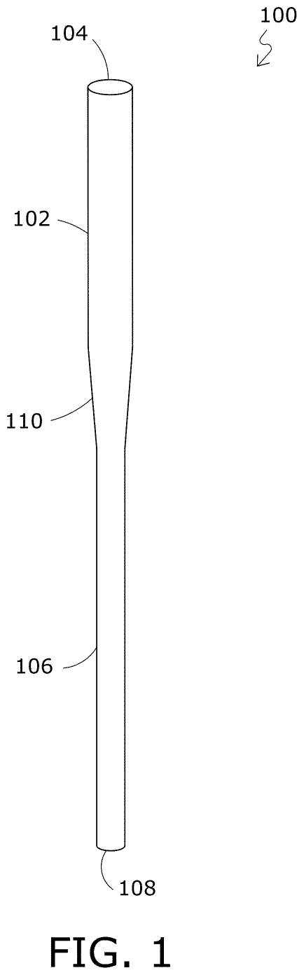

### DESCRIPTION OF PREFERRED EMBODIMENTS

Referring to the drawings a golf shaft 100 is formed of an upper butt section 102 having an upper end 104 with a first constant diameter along the length thereof. The shaft 100 has a lower section 106 the terminates at a tip end 108 that is inserted into or otherwise connected to a conventional golf club head, not shown. The lower section 106 has a second constant diameter smaller than the first constant diameter.

The upper butt section 102 and the lower section 106 are integrally connected by a rapidly tapering section 110. Typically, the first upper butt section 102 has an outside diameter of 0.590 to 0.640 inches whereas the outside diameter of the lower section is 0.035 to 0.390 inches. The rapidly tapering section 110 creates a diameter reduction of the shaft 100 whereby the lower section 106 has a diameter of approximately 38% of the diameter of the upper butt section 102.

This golf shaft 100 that incorporates a unique, rapidly tapering section 110 between the upper butt section 102 and lower section 106 will increase club head speed. by 2-6 mph resulting in increased distance that a golf ball will travel using the shaft. The rapidly tapering, geometric intermediate section 110 creates a “whip” effect that uses the stored energy created during swing evidenced by the shaft bending; and more effectively releases that energy increasing the club head speed during the final angular acceleration at impact.

In all embodiments of the shaft 100 of the present invention, the rapid tapering section 110 is positioned relative to the upper end 104 of the shaft at a location determined by the overall weight of the shaft. Preferably the rapid tapering section is closer to the upper end when the shaft 100 is the lightest and located further away from the upper end 104 as the overall shaft weight increases.

Typical embodiments of a driver club and/or a fairway wood shaft 100 locate the rapid tapering section 110 approximately 15.5 inches from the upper end 104 when the overall weight of the shaft is less than 55 grams. Likewise, as the weight of the shaft increases in 10 gram increments, the rapid tapering section 110 is located approximately one inch further from the upper end 104 of the shaft 100.

Iron and hybrid clubs use shafts that are heavier than those described above. An example of an iron shaft 100 that weighs 75 grams, locates the rapid tapering section 110 14.5 inches from the upper end 104 of the shaft 100. These shafts also locate the rapid tapering section 110 in increments of approximately one inch further from the upper end 104 of the shaft with each 10 gram increase in the overall weight of the shaft 100.

Examples of shafts for both metal woods and fairway metal woods and for iron and hybrid shafts are listed as follows disclosing specific shaft weights and rapid taper locations for the shafts as well as ranges of these parameters.

Wood and Fairway Wood Shafts

Weight 1: Less than 55 grams

Length: 44″ to 46″ (raw/untrimmed length)

Beginning of Taper from Butt End: 15.5″+/−2.5″.

Length of Taper: 3.5″+/−2.5″

Outside diameter reduction: 38%+/−4%

Weight 2: 55-65 grams

Length: 44″ to 46″ (raw/untrimmed length)

Beginning of Taper from Butt End: 16.5″+/−2.5″.

Length of Taper: 3.5″+/−2″

Outside diameter reduction: 38%+/−4%

Weight 3: 65-75 grams

Length: 44″ to 46″ (raw/untrimmed length)

Beginning of Taper from Butt End: 17.5″+/−2.5″

Length of Taper: 3.5″+/−2″

Outside diameter reduction: 38%+/−4%

Iron and Hybrid Shafts

Weight 1: 75+/−5 grams

Length: 39-42″ (raw/untrimmed length)

Beginning of Taper from Butt End: 14.5″+/−2.5″

Length of Taper: 3.75″+2″/−1.5″

Outside diameter reduction: 32%+/−4%

Weight 2: 85+/−5 grams

Length: 39-42″ (raw/untrimmed length)

Beginning of Taper from Butt End: 15.5″+/−2.5″

Length of Taper: 3.75″+/−2″

Outside diameter reduction: 32%+/−4%

Weight 3: 95+/−5 grams

Length: 39-42″ (raw/untrimmed length)

Weight 3: 95+/−5 grams

Beginning of Taper from Butt End: 16.5″+/−2.5″.

Length of Taper: 3.75″+/−2″

Outside diameter reduction: 32%+/−4%

Weight 4: 105 grams or more

Length: 46″ (raw/untrimmed length)

Beginning of Taper from Butt End: 17.5″+/−2.5″.

Length of Taper: 3.75″+/−2″

Outside diameter reduction: 32%+/−4%

Shafts made in accordance with the above listed parameters and ranges increase club head speed that, in turn, will also result in creating more distance for a golfer without a change in the club head physical parameters or the golf ball used for the mechanics of any particular golf swing.

A preferred method of making a golf shaft of the present invention having an upper butt section, a lower tip section and a rapidly tapering, intermediate section connecting the upper butt section and the lower tip section is described in my U.S. Pat. No. 1,061,596 titled Method of Filament Winding a Variable Diameter Golf Shaft. The patent describes forming the upper butt section in a cylindrical configuration having a first diameter; forming the lower tip section in a cylindrical configuration having a second diameter less than the first diameter of the upper butt section; and, forming the tapering intermediate section with a first end connected to the upper butt section and having a diameter equal to the first diameter and with a second end connected to the lower tip section and having a diameter equal to the second diameter.

The improvement of the present invention includes a first step of measuring the overall weight of the materials used to make the shaft before the shaft is made to obtain a preselected shaft weight after it is formed. This is accomplished by measurement of the winding filament and or the prepreg material and the curing material that is typically used to form the shaft.

Once the weight of the shaft is known, the tapered intermediate section is positioned or located relative to an upper edge of the upper butt section depending upon the preselected weight of the shaft. In accordance with the principles of the invention, the intermediate section is located further from the upper edge of the upper butt section as the overall weight measurement of the shaft increases. Likewise, the intermediate, rapid tapering, section is located closer to the upper edge of the upper butt section as the overall weight of the shaft decreases or becomes lesser. Specific examples of shafts made using this described method including shaft weight and locations of the rapidly tapering sections relative to the upper end of the shaft are listed hereinabove.

It will be appreciated that shafts made in accordance with this invention are not limited to the specific values presented herein. Other shaft weights and locations of the tapering section may be used within the spirit and scope of the following claims.

1. A golf shaft for connection to a golf club head including a first upper section having a first diameter and an upper butt end; a second lower section having a second lesser diameter than said first diameter and a lower tip end for connection to said golf club head; an intermediate section connected between said first section and said second section; said intermediate section having a diameter equal to said first diameter at a junction of said first upper section and said intermediate section tapering to a diameter equal to said second diameter at a junction of said second lower section and said intermediate section, wherein the improvement comprises: a location of said intermediate section relative to said upper butt end; said location being determined by a weight value of said shaft.

2. The golf shaft of claim 1 wherein said location is positioned closer to said butt end as the weight value of said shaft decreases.

3. The golf shaft of claim 2 wherein said second lesser diameter is within a range of 30 to 40 percent reduction of the diameter of said first diameter of said first upper section.

4. The golf shaft of claim 3 wherein said location of said intermediate section is within a range of 12 to 18 inches from the upper butt end of said shaft.

5. The golf shaft of claim 4 wherein said shaft has a weight of approximately 55 grams and said intermediate section has a location approximately 15.5 inches from said upper butt end of said shaft.

6. The golf shaft of claim 4 wherein said shaft has a weight of approximately 65 grams and said intermediate section has a location approximately 16.5 inches from said upper butt end of said shaft.

7. The golf shaft of claim 4 wherein said shaft has a weight of approximately 75 grams and said intermediate section has a location approximately 17.5 inches from said upper butt end of said shaft.

8. The golf shaft of claim 4 wherein said shaft weighs approximately 75 grams and said intermediate section has a location approximately 14.5 inches from said upper butt end of said shaft.

9. The golf shaft of claim 4 wherein said shaft weighs approximately 85 grams and said intermediate section has a location approximately 15.5 inches from said upper butt end of said shaft.

10. The golf shaft of claim 4 wherein said shaft weighs approximately 95 grams and said intermediate section has a location approximately 16.5 inches from said upper butt end of said shaft.

11. The golf shaft of claim 4 wherein said shaft weighs approximately 105 grams and said intermediate section has a location approximately 17.5 inches from said upper butt end of said shaft

12. A golf shaft for connection to a golf club head including a first upper section having a first diameter and an upper butt end; a second lower section having a second lesser diameter than said first diameter and a lower tip end for connection to said golf club head; and, a gradually tapering intermediate section connected between the first upper section and the second section that reduces the outside diameter of the shaft from the diameter of the upper section to the diameter of the lower section, wherein the improvement comprises: a location of said intermediate section relative to said upper butt end of said shaft; said location being determined by a weight value of said shaft.

13. A method of making a golf shaft having an upper butt section, a lower tip section and a tapered intermediate section connecting the upper butt section and the lower tip section including the steps of:
a) forming said upper butt section in a cylindrical configuration having a first diameter;
b) forming said lower tip section in a cylindrical configuration having a second diameter lesser than said first diameter of said upper butt section;
c) forming said tapered intermediate section with a first end connected to said upper butt section and having a diameter equal to said first diameter and with a second end connected to said lower tip section and having a diameter equal to said second diameter;
wherein the improvement comprises:
measuring the overall weight of the materials used to make shaft to obtain a preselected shaft weight;
locating said tapered intermediate section relative to an upper edge of said upper butt section in accordance with said preselected weight measurement.

14. The method of claim 13 further including the step of positioning said intermediate section further away from said upper edge of said upper butt section as the overall weight measurement of the shaft increases.

15. The method of claim 13 further including the step of positioning said intermediate section closer to upper edge of said upper butt section as the overall weight measurement of the shaft decreases.
